(19) United States
(12) Patent Application Publication
(10) Pub. No.: US 2019/0321777 A1
(43) Pub. Date: Oct. 24, 2019

(54) Carbon dioxide sequestering filter

(71) Applicant: Richard Gerlach, Sudbury (CA)

(72) Inventor: Richard Gerlach, Sudbury (CA)

(21) Appl. No.: 15/932,758

(22) Filed: Apr. 23, 2018

(51) Int. Cl. B01D 53/62

(52) U.S. Cl. CPC B01D 53/62; B01D 2251/402; B01D 2257/504

(57) ABSTRACT

Three methods of sequestering carbon dioxide from the atmosphere that uses an enhanced weathering effect of the mineral olivine. In method one, crushed olivine is bonded to a substrate to create a filter that sequesters carbon dioxide. Method two contains the crushed olivine between two pieces of filter media to create a filter that sequesters carbon dioxide. The third method uses an unobstructed containment structure loaded with crushed olivine to create a filter that sequesters carbon dioxide.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Carbon dioxide, along with other greenhouse gases, are responsible for the greenhouse effect, which is causing the Earths' temperature to rise. Reducing greenhouse gases would, in theory, reduce the greenhouse effect and stop the rise in the Earths' temperature. The most common greenhouse gas is water vapour, which is variable, in its presence in the atmosphere and cannot be controlled. Carbon dioxide is the second most important greenhouse gas and it is controllable. Current efforts to control the amount of carbon dioxide in the atmosphere include the reduction in the use of fossil fuels, sequestering carbon dioxide at the site where large amounts of fossil fuels are consumed in industrial processes, and sequestering some of the carbon dioxide already in the atmosphere.

Current carbon sequestering involves expensive, energy consuming, large scale systems that process flue gases and must be installed at the site of the carbon dioxide emission. The carbon dioxide emissions at the site of large scale sequestering is generally 10% or more of the flue gases. The high amount of carbon dioxide in industrial emissions justifies the money spent to sequester the carbon dioxide because there is lots of it (carbon dioxide) to sequester at one location.

Sequestering carbon dioxide from the atmosphere needs a different approach. The concentration of carbon dioxide in the atmosphere is about 0.04%. Large scale sequestering of carbon dioxide from the Earths' atmosphere is not practical due to the low concentrations. A recent proposal is to crush and spread the mineral olivine over the surface of the earth and in the oceans. The mineral olivine and other silicate minerals sequester carbon dioxide through natural weathering when exposed to the atmosphere. The proposal to spread olivine or other silicate minerals on the earth would be energy intensive, expensive, and time consuming. The natural weathering process is slow in sequestering carbon dioxide because the air movement over the silicate mineral is provided by nature and is variable or non-existent at times.

This new process is the opposite of current technology that sequesters large amounts of carbon dioxide at a small number of locations, and instead sequesters small amounts of carbon dioxide at a large number of locations. This invention is focused on the use of silcate minerals, as a filter, in the path of artifical moving air, to sequester the low concentration of carbon dioxide from the Earths' atmosphere. All silicate minerals that sequester carbon dioxide can be considered useable by this process where practical. This invention will use olivine as the silicate mineral due to its abundance in the Earths' crust. Less than one litre of olivine can sequester all of the carbon dioxide released by burning one litter of oil. This invention will enhance the natural weathering of the olivine mineral to speed up the sequestering of carbon dioxide by using the olivine, as a filter, in the path of artificial moving air. This invention will be low cost, small scale (although it can be scaled up), and widely available, so that a homeowner can participate in the sequestering of carbon dioxide. This invention will result in small amounts of carbon sequestering at a large number of locations.

### REFERENCES

Bill Freedman and Todd Keith, Department of Biology and School for Resource and Enviromental Studies, Dalhousie Unibversity, Halifax, Nova Scotia, Canada, “Planting Trees For Carbon Credits”, A discussion of the Issues, Feasibility, and Enviromental Benefits prepared for the Tree Canada Foundation pages 1-11.
The Economist, Nov. 18, 2017. edition, Briefing; Combating climate change, “Sucking up carbon” pages 20-22.
Wikipedia, Olivine. pages 1-8.

### BRIEF SUMMARY OF THE INVENTION

This invention is a process of sequestering carbon dioxide from the Earths' atmosphere. This process of sequestering carbon dioxide is done by three different methods of placing the silicate mineral olivine in the path of artificial moving air. All three methods are very cost effective to execute, as compared to current efforts to sequester carbon dioxide from the atmosphere. All three methods use little energy to operate when used as described.

The first method involves bonding crushed olivine to a substrate. The substrate is installed in the path of artificial moving air, parallel to the air flow. As the air flows over the olivine bonded to the substrate, a weathering effect takes place with the olivine. The weathering effect sequesters carbon dioxide from the air, that flowed over it.

The second method involves loosely packing crushed olivine between two pieces of filter paper and sealing the edges to create a filter pack. The filter pack is installed in the path of artificial moving air, perpendicular to the air flow. As the air flows through the filter pack containing the olivine, a weathering effect takes place with the olivine. The weathering effect sequesters carbon dioxide from the air, that flowed through it.

The third method involves piling coarsely crushed olivine in an unobstructed containment structure mounted in the path of artificial moving air. As the air flows through the olivine contained in the structure, a weathering effect takes place with the olivine. The weathering effect sequesters carbon dioxide from the air, that flowed through it.

### BRIEF DESCRIPTION OF THE SEVERAL VIEWS OF THE DRAWINGS

Not Applicable

### DETAILED DESCRIPTION OF THE INVENTION

This invention is a process of sequestering carbon dioxide from the Earths' atmosphere using enhanced weathering of silicate minerals. This invention will function with the use of many silicate minerals or a combination of silicate minerals. The use of the mineral olivine is described here due to its abundance on earth, but this invention is not limited to olivine only.

Enhanced weathering is done by placing the mineral olivine in the path of artificial moving air. The artificial moving air is provided by many sources such as central heating/cooling systems and ventilation systems that are present in residential, commercial and industrial buildings. Other minor sources of artificial moving air are vacuum cleaners, automobile cabin ventilation, and kitchen exhaust fans.

This invention can be carried out by three different methods, depending on the location in which the carbon dioxide is to be sequestered, as mentioned in the above paragraph. There are many variables in artificial moving air systems including the speed of the air flow, the volume of the air flow, and the size of the ductwork. The variables will determine the size of the crushed olivine, the substrate size, the construction of the substrate, and the containment system used for the olivine.

The term “air filter” means the air filter that cleans the air of dirt. The term “carbon dioxide sequestering filter” means the invention.

The first method involves bonding the crushed olivine to a substrate. The substrate in this case can vary from heavy paper to paperboard. Once the olivine is bonded to the substrate, the combination becomes a “carbon dioxide sequestering filter”. The “carbon dioxide sequestering filter” is installed in the ductwork of artificial moving air, in front of the “air filter”, parallel to the air flow. As the air flows through the “carbon dioxide sequestering filter”, an enhanced weathering effect takes place with the olivine, sequestering carbon dioxide from the air that flowed through it. The “carbon dioxide sequestering filter” can be integrated with the “air filter” as one unit to simplify installation, or the “carbon dioxide sequestering filter” can be an independent unit.

The second method involves loosely packing crushed olivine between two pieces of filter media with sealed edges to create a “carbon dioxide sequestering filter”. The “carbon dioxide sequestering filter” is installed in the ductwork of artificial moving air, perpendicular to the air flow. As the air flows through the “carbon dioxide sequestering filter”, an enhanced weathering effect takes place with the olivine, sequestering carbon dioxide from the air that flowed through it.

The third method involves placing an unobstructed containment structure in the path of artificial moving air, at the output of the ductwork. Coarsely crushed olivine is loaded in the containment structure to form a “carbon dioxide sequestering filter”. As the air flows through the olivine contained in the structure, an enhanced weathering effect takes place. The enhanced weathering effect sequesters carbon dioxide from the air that flowed through it.

1. The invention claimed is the bonding of crushed olivine to a substrate to create a carbon dioxide sequestering filter.

2. The invention claimed is the containment of crushed olivine between two pieces of filter media to create a carbon dioxide sequestering filter.

3. The invention claimed is the containment of crushed olivine in an unobstructed containment structure to create a carbon dioxide sequestering filter.

4. The invention claimed is as in claim 1 in which the carbon dioxide sequestering filter created is integrated with a dirt filtering air filter as one unit.

5. The invention claimed is as in claim 1, 2, or 3 in which the silicate mineral used is other than olivine.

6. The invention claimed is as in claim 1, 2, or 3 in which the silicate mineral used is a combination of silicate minerals.
